(19) United States
(12) Patent Application Publication
(10) Pub. No.: US 2006/0095195 A1
(43) Pub. Date: May 4, 2006

(54) Vehicle operation control device

(75) Inventors: Takao Nishimura, Nagoya-city (JP); Yoshihiko Teguri, Okazaki-city (JP); Kazuyoshi Isaji, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/266,733

(22) Filed: Nov. 3, 2005

(30) Foreign Application Priority Data
Nov. 4, 2004 (JP) 2004-321147

(51) Int. Cl. G06F 17/00

(52) U.S. Cl. 701/96; 701/117

(57) ABSTRACT

A vehicle operation control device utilizes a plurality of sensors and receivers to develop an absolute rule set and a relative rule set that take into account the capabilities of the vehicle, the condition of the roadway, the preferences of the operator and the operation of surrounding vehicles. The vehicle operation control device uses information from both an absolute rule set and a relative rule set to define a set of operating principles that can be varied as necessary to improve safely and the comfort of the operator and/or the passengers within the controlled vehicle. The absolute rule set is based primarily on road information and operating regulations with which an operator should normally comply during operation of any vehicle. The relative rule set is based primarily on the relative positioning and movement of other vehicles in the vicinity of the controlled vehicle or farther along the intended path.

### PRIORITY STATEMENT

This application claims priority pursuant to 35 U.S.C. § 1.119 from Japanese Patent Application No. 2004/321147, which was filed on Nov. 4, 2004, the contents of which are hereby incorporated, in their entirety, by reference.

### BACKGROUND OF THE INVENTION

1. Field of the Invention

This invention relates to a vehicle operation control device.

2. Description of the Related Reference

Adaptive cruise control devices are typically configured for controlling the distance between a controlled vehicle and a leading vehicle while lane maintenance control devices are typically configured for controlling the position of a controlled vehicle within the intended or selected lane. Both of these control devices are discussed as conventional technology concerning the vehicle operation control devices in printed references including, for example, JP2003-48450A.

These conventional vehicle control systems, however, have several deficiencies in that they can fail to compensate safely for situations commonly encountered during vehicle operation. One such situation occurs when a controlled vehicle approaches a controlled street crossing through which the controlled vehicle does not have the right-of-way due to a stop signal, pedestrian traffic, police control or emergency vehicle operation. If the adaptive cruise control is engaged and the leading vehicle enters goes into and/or proceeds through the street crossing without stopping, the controlled vehicle will typically follow the leading vehicle into the intersection absent some rapid intervention by the operator.

Another situation occurs when the controlled vehicle passes or is passed by an oncoming vehicle or adjacent vehicle on a curved road segment, particularly if the oncoming or adjacent vehicle does not maintain a centered position within its travel lane and approaches or crosses the intervening lane divider. In such situations, most operators would prefer to adjust the position of the controlled vehicle temporarily to a position within the intended lane that is shifted away from the lane divider. However, when a conventional lane maintenance control device is engaged, it tends to center the controlled vehicle within the selected lane. By failing to account for the intrusion or potential intrusion of other vehicles into the selected lane of the controlled vehicle, the conventional lane maintenance control device decreases the safety margin and/or the comfort level of the operator and/or passengers present in the controlled vehicle.

These deficiencies associated with conventional adaptive cruse control and lane maintenance control devices typically result from the particular combination of fixed or absolute requirements or parameters being used by the control devices in directing the operation of the controlled vehicle, such as lane selection and/or maintenance and signal responses, or a set of relative requirements, such as the target spacing from a nearby vehicle, for example, a leading vehicle and/or passing or pacing vehicles. Therefore, related technology was difficult to reconcile the safety and comfortable feeling in operation control.

### SUMMARY OF THE INVENTION

Embodiments of the invention provide for improved vehicle control devices that address the deficiencies in the conventional art control devices in a manner that can improve the safety and/or the comfort of the operator and/or passengers in the controlled vehicle and thereby promote more relaxed and secure feelings among the occupants during vehicle operation.

Embodiments of the invention provide for improved vehicle control devices that utilize a combination of both relative parameters and absolute parameters for adjusting the operation of the vehicle, thereby providing a range of adaptability not provided by conventional control devices that rely on either relative parameters or absolute parameters for vehicle operation. As a result of the increased adaptability, operation of a controlled vehicle by control devices according to embodiments of the invention will tend to improve the safety and/or the comfort of the operator and/or passengers, thereby promoting more relaxed and secure feelings among the occupants of the controlled vehicle.

Embodiments of vehicle operation control devices according to the invention claim do not rely only on an absolute rule set (the rule set comprising at least one rule) derived from information available concerning the intended path of the controlled vehicle, but instead define a preliminary rule set that may be adapted or otherwise modified and/or supplemented. The adaptations to the preliminary rule set may be based on information concerning the road conditions, adjacent or approaching vehicles or obstructions, the intended route, the vehicle capabilities and condition, the operator's and/or passenger's preferences and habits.

Accordingly, embodiments of vehicle operation control devices according to the invention claim can adapt the operating rule set in response to variations in external environmental conditions and parameters, for example, dry or wet road surfaces, smooth or rough road surfaces, traffic control signal status, road signs, vehicular flow patterns, traffic signs, intersecting, crossing or merging roadways, length and radius of approaching curved portions of the roadway. Similarly, information regarding surrounding vehicular or pedestrian traffic, such as a leading vehicle, a following vehicle, passing vehicles, pacing vehicles and/or the location and extent of traffic congestion can be acquired and considered for adapting the operating rule set.

### BRIEF DESCRIPTION OF THE DRAWINGS

The invention will become more apparent by describing in detail exemplary embodiments thereof with reference to the attached drawings in which:

FIG. 1 is a block diagram illustrating an embodiment of a whole vehicle operation control device 100 according to the invention;

FIG. 2 illustrates an embodiment of a control block diagram of a control device 18 according to the invention;

FIG. 3 is a flow chart illustrating an embodiment of a flow of vehicle operation control processing that can be utilized for practicing the invention;

FIG. 4 is a flow chart illustrating an embodiment of a flow of operation-characteristics setting processing that can be utilized for practicing the invention;

FIG. 5A is the FIGURE having illustrated the situation of approaching the crossing which a red signal is turning on, performing adaptive cruise control, FIG. 5B is the FIGURE showing the speed change pattern (control rule) based on each rule and FIG. 5C is the FIGURE showing the change pattern of acceleration and deceleration based on each rule (control rule);

FIG. 6A is a FIGURE illustrating the situation run a curve way performing adaptive cruise control, FIG. 6B is a FIGURE illustrating the absolute rule combined-use area in a curve way, FIG. 6C is a FIGURE illustrating the speed change pattern (control rule) based on each rule, and FIG. 6D is a FIGURE illustrating the change pattern of acceleration and deceleration based on each rule (control rule); and

FIG. 7A is a FIGURE illustrating the situation in which a vehicle operational control system according to the invention performs adaptive cruise control functions as the controlled vehicle approaches a curved portion of a roadway and FIG. 7B is a FIGURE illustrating the response of the control system to an oncoming vehicle that approaches the center line or lane divider as the controlled vehicle proceeds along the curved portion of the roadway.

These drawings have been provided to assist in the understanding of the exemplary embodiments of the invention as described in more detail below and should not be construed as unduly limiting the invention. In particular, the relative spacing, positioning, sizing and dimensions of the various elements and/or vehicles illustrated in the drawings are not drawn to scale and may have been exaggerated, reduced or otherwise modified for the purpose of improved clarity.

Those of ordinary skill in the art will also appreciate that a range of alternative configurations have been omitted simply to improve the clarity and reduce the number of drawings. Those of ordinary skill will appreciate that certain of the various of the control parameters illustrated in the FIGURES or described in the specification with respect to the exemplary embodiments may be selectively and independently combined to create other vehicle control systems and methods useful for vehicular operational control without departing from the scope and spirit of this disclosure.

### DETAILED DESCRIPTION OF EXAMPLE EMBODIMENTS

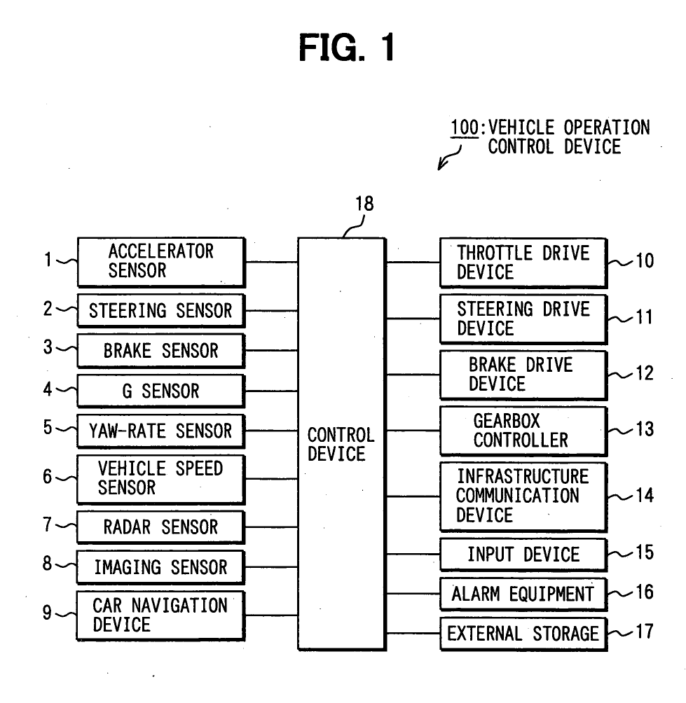

Embodiments of vehicle operation supporting devices that may be utilized for practicing the invention are described below in reference to a number of FIGURES. An embodiment of a whole vehicle operation control device configuration according to the invention is illustrated in FIG. 1. As illustrated in FIG. 1, an exemplary vehicle operation control device 100 is provided with a variety of sensors and controllers that may include, for example, an accelerator sensor 1, a steering sensor 2, a brake sensor 3, a G sensor (vehicle acceleration sensor) 4 (as used herein, unless otherwise indicated, the term “acceleration” is intended to encompass both acceleration and deceleration), a yaw-rate sensor 5, a vehicle speed sensor 6, one or more radar sensor 7, an imaging sensor 8 and a vehicle navigation device 9.

As will be appreciated by those skilled in the art, this particular set of sensors is not exclusive and other or different sensors could be incorporated more closely align the vehicle operation control sensors with the particular environment in which the vehicle operation control device is intended to operate. Other sensors may include, for example, tire pressure sensors, tire temperature sensors, suspension setting sensors, fuel level sensors, and various engine management sensors.

As illustrated in this FIG. 1, an exemplary vehicle operation control device 100 also includes a range of control devices that may include, for example, a throttle drive device 10, a steering drive device 11, a brake drive device 12, a gearbox controller 13, an infrastructure communication device 14, an input device 15, alarm equipment 16, and an external storage 17.

As will be appreciated by those skilled in the art, this particular set of controllers is not exclusive and other or different controllers could be incorporated more closely align the vehicle operation controllers with the particular environment in which the vehicle operation control device is intended to operate. Other sensors may include, for example, suspension controllers (for use with active suspensions), window shade controllers, environmental controllers and/or power level controllers.

A control device 18 is the principal part of a vehicle operation control device 100, and typically constitutes one or more microcomputers. The control device 18 may be configured or assembled from known components including various CPU, ROM, RAM, interfaces (I/O), and a bus or other suitable configuration for system communication. As the basic components are fairly conventional and, therefore, within the knowledge and understanding of one of ordinary skill in the vehicle control arts, a detailed discussion of each of the various components is omitted.

The control device 18 collects the information from various sensors or other data receiving apparatus and, based on this data and the operating rule set, determines whether modification of the various operational parameters is necessary and the settings needed to provide the desired level of control. Based on the information received from the various sensors, additional data and current operational status, the control device 18 determines how to adjust the settings of various vehicular control functions including, for example, a the throttle drive device 10, a steering drive device 11, a brake drive device 12, a gearbox controller 13, based on the collected information.

The control device 18 then, for example, performs various vehicle operation control processing to provide an adaptive cruise control that controls the speed of controlled vehicle to maintain a generally appropriate distance and/or time interval between the controlled vehicle and a leading vehicle (or the time interval detected between two vehicles) traveling in the same roadway lane.

For example, the accelerator sensor 1 may be configured to detect acceleration or deceleration initiated by the operator of the controlled vehicle or resulting from an external cause, e.g., a change in the incline of the roadway down which the controlled vehicle is proceeding. A steering sensor 2 may be configured to detect the amount of change of the steering angle of the steering wheel, the actual position of the steered wheels and/or other suspension components. The brake sensor 3 may be configured to detect the existence (On/Off) of brake operation by the operator as well as the relative magnitude of the braking effort the operator wishes to exert on the vehicle. The information collected by the various sensors regarding the operation and/or configuration of various components of the controlled vehicle is then transmitted, at one or more substantially constant rate(s) and/or one or more variable rates, to the control device 18 for processing.

The G sensor 4 may be configured to detect acceleration along at least one reference axis, such as a central longitudinal axis of the vehicle. Preferred embodiments of the G sensor 4 are configured to detect acceleration along more than one reference axis, e.g., longitudinal acceleration, lateral acceleration and vertical acceleration which detects the acceleration of the vehicle along at least three reference axes. The yaw-rate sensor 5 may be configured to detect the angular velocity (yaw-rate) with which the heading of the controlled vehicle is varying around an axis of rotation, particularly in a direction generally perpendicular to the central longitudinal reference axis of controlled vehicle. An embodiment of vehicle speed sensor 6 may include one or more sensors configured to detect the rate of rotation of a controlled vehicle wheel and thereby determine the speed of the controlled vehicle from the performance of the monitored wheel.

A radar 7 assembly may be configured to emit light waves, such as radiofrequency (RF) waves, in continuous and/or, more frequently, pulsed emission modes in prescribed directions, angles and energies. A portion of these RF signals reflected from objects in the vicinity of the controlled vehicle are, in turn, detected and analyzed to determine the distance, relative velocity and the direction of the detected objects, relative to the center longitudinal reference axis and/or the current and/or anticipated directional vector(s) of the controlled vehicle. Detected objects may include, for example, the leading vehicle and/or oncoming vehicles, pedestrians and/or fixed obstructions such as guard rails, mail boxes and fire hydrants.

One or more controlled imaging sensors 8 may be configured for attachment to various portions of the controlled vehicle, particularly configurations that will provide images looking forward and/or backward from the controlled vehicle along the longitudinal reference axis. For example, imaging sensors may be configured to utilize a semiconductor device, such as a CCD (Charge Coupled Device) and may be coupled with additional hardware or software that provides processing and/or storage of the retrieved images. The camera and/or lens or focusing system utilized in the imaging sensor 8 will typically provide for adjustment of shutter speed, frame rate, and the gain of the picture digital signal as output to an image processing portion etc. The software may include image recognition code that will recognize certain of the objects detected by the imaging sensor.

When a traffic signal is installed the white line position of right and left of a intended lane, and ahead, an imaging sensor 8 can recognize the control state (i.e., whether the displayed lighting state (red, yellow or green) of a signal being approached by the controlled vehicle. The imaging sensor 8 outputs picture information to a control device 18.

A vehicle navigation device 9 detects the current position of controlled vehicle by determining the position of the sensor portion of the controlled vehicle relative to a series of geosynchronous satellites that form a global positioning system (GPS). Car navigation devices 9 are also typically equipped with maps that can be combined with the detected position to illustrate the location of the controlled vehicle. Depending on the complexity of the GPS system and the accuracy of the maps used in conjunction with the GPS information, the vehicle navigation system may be able to identify potential routes to a destination based on various operator selected criteria, e.g., fastest, shortest distance, availability of particular fuels and no highways. Other criteria for route determination can include external data such as construction alerts, bridge openings and isolated pockets of traffic congestion, which may, in turn, be used to evaluate a series of possible routes for identification of the “best” current route or a more suitable alternative route to the intended destination. The structure and operation of suitable GPS systems is sufficiently well known that one of ordinary skill in the vehicular control technology would have both knowledge and understanding of this technology sufficient to avoid any need for a detailed explanation of GPS system operation.

Most GPS systems include a map data input device that stores map data comprising, for example, road data, index data, drawing data, available services, etc., from which the GPS system extracts the appropriate position data. The map data input devices may utilize one or more data storage devices selected from, for example, CD-ROM, DVD-ROM, flash memory, a memory card, a hard disk or other suitable data storage device onto which the necessary map data can be written to or “burned” to provide local and/or network storage.

The map data will typically include both node and link data which together constitute the basic road data. A node is defined at each point where one roadway crosses, branches, merges or joins another roadway with each link being a portion of a roadway between two nodes. Consistent with this terminology, a roadway is defined as a series links connected through a corresponding series of nodes.

The data for each link typically includes, for example, a specific identifier or number unique to a single link (link ID); link length; link coordinates corresponding to the starting point and the ending or termination point for the link (latitude and longitude data); link configuration (street width, traffic direction(s)); and link radius (curvature).

The data for each node typically includes, for example, a specific identifier or number unique to a single node (node ID); identification of each link that terminates at the designated node; node coordinates (latitude and longitude) and other relevant node attributes; the point attributes corresponding to each branch, unification, merge and intersection; and the installation coordinates (latitude, longitude, and height from the ground) and the type of each traffic signal, road sign and traffic indicators (including those painted on the roadway surface).

The vehicle control system can include a display such as, for example, a light emitting diode (LED) display, a liquid crystal display (LCD) or other display means suitable for use in a vehicle. The display can be used to indicate the current position of the controlled vehicle as an overlay on map data using position data from the integrated GPS system and surrounding map data retrieved from the map data input device.

In response to the order signal from a control device 18, the vehicle navigation device 9 outputs the current controlled vehicle position data to a control device 18. This data typically includes the road data (link data and node data) for those portions of roadways within a prescribed distance from the current position of the controlled vehicle.

Using the data from the navigation device 9 and the other sensors, the control device 18 determines a target setting for each of the controllers and the adjustment required to achieve the target setting. Each of the controlled devices then responds to the orders from a control device 18, thereby setting the condition of, for example, the throttle drive device 10, the steering drive device 11, the brake drive device 12 and the gearbox controller 13. The throttle drive device 10 adjusts the opening of a throttle valve or corresponding control to adjust the power output of the engine, motor or hybrid power systems used to propel the controlled vehicle. The steering drive device 11 adjusts the position of the steering gear to maintain or adjust the direction of movement of the controlled vehicle. The brake drive device 12 may be engaged by adjusting braking pressure power for slowing the controlled vehicle. The gearbox controller 13 is used to select an appropriate power transmission setting for utilizing the current power output and achieving the desired speed, acceleration and/or efficiency for the drive train.

The infrastructure communication device 14 is configured for receiving the variety of information from external infrastructure equipment. For example, the infrastructure communication device 14 may be configured for receiving short range or limited area communications, such as VICS or DSRC. For example, the infrastructure communication device 14 may be configured for receiving VICS (Vehicle Information and Communication System) transmissions providing road traffic information sent from the VICS-center via a FM broadcast office or a beacon or repeater provided adjacent the roadway. Or the infrastructure communication device 14 may also be configured for receiving DSRC (Dedicated Short Range Communication) transmissions in narrow spaces such as ETC (Electrical Transfer Control) for communication between the roadway and adjacent vehicles.

The road traffic information provided via VICS may include, for example, traffic jam information identified by the coordinates of the affected links and/or nodes; a qualitative assessment of the degree of traffic congestion or average speed for each link in the anticipated routes and/or alternative routes; an estimate of the travel time necessary to traverse each link; regulation information, such as a highway entrance closing, lane closures, work zones and/or accidents or other obstructions.

The degree of traffic congestion may be is expressed in two or more evaluation stages including, for example, above posted speeds, at posted speeds, below posted speeds, very slow and stopped. The received road traffic information can be displayed on the appropriate links on the road map display provided on the screen of the vehicle navigation device 9. This road traffic information is outputted to a control device 18.

The information provided by DSRC transmissions can include, for example, speed and position information for oncoming vehicles where the view is obstructed in some manner, such as on a “blind” curve or other obstruction. The information corresponding to the oncoming vehicle is transmitted as the oncoming vehicle approaches controlled vehicle. The information transmitted may include, for example, the type of vehicle approaching vehicle (car, truck, bus), the speed of the oncoming vehicle, and the positioning of the oncoming vehicle within the travel lane(s), e.g., the position within the travel lane (centered, offset toward shoulder, offset toward opposing traffic, in opposing travel lanes) and, in multi-lane roadways, the current travel lane, over the center line, etc.). This oncoming vehicle information is provided to control device 18.

A touch screen, a series of mechanical switches or other suitable switch, selector or indicator assemblies may be combined with the display of the vehicle navigation device 9 to provide an input device 15 that may be engaged or utilized by the operator to set, adjust or respond to various conditions in the vehicle operation control device and/or vehicle navigation device. During operation of the vehicle operation control processing mentioned above, alarm equipment 16 may be utilized for generating one or more types of alarm signals to alert the operator to an unsafe condition or signal a need for a necessary operator input.

An external storage 17 device may be provided with the storage medium of a memory card, a hard disk or other suitable storage medium to which data can be stored and from which data can be retrieved. For example, the external storage 17 may be utilized to store current and/or historical information relating to various operational characteristics of the controlled vehicle. Such information may include: the acceleration characteristics of the power plant(s) utilized in the controlled vehicle, e.g., torque curves, power curves, battery status and motor configuration; the brake system performance relating to vehicle weight, tire configuration and compound, disc and pad material, caliper performance, brake system pressure and temperature. In response to an order from the control device 18, the external storage 17 provides the requested information (such as various operational characteristics).

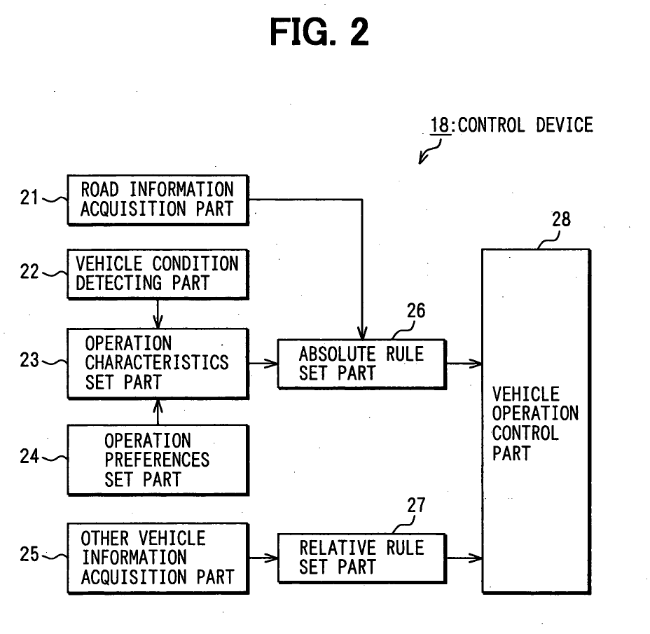

FIG. 2 illustrates a control block diagram for an embodiment of a control device 18 according to the invention. As illustrated in FIG. 2, the control device 18 includes a number of distinct functional blocks including a road information acquisition part 21, a vehicle condition detecting part 22, a operational characteristics set part 23, the operator preferences set part 24, and other vehicle information acquisition parts 25. The output data or signals from various of these parts are then provided to an absolute rule set part 26 and/or a relative rule set part 27. The output data or signals from the rule set parts 26, 27 are then provided to the vehicle operation control part 28 for final processing.

The road information acquisition part 21 can acquire image information (e.g., the white lines defining the right and left limits of a travel lane, traffic signal state, etc.) from an imaging sensor 8, and the vehicle navigation information (road data corresponding to the roadway for a prescribed distance ahead of the controlled vehicle) from a vehicle navigation device 9. In this manner, the road information acquisition part 21 acquires a variety of detailed information relating to the conditions of the roadway including signals, road signs, traffic signs, crossings, curved portions of the roadway, etc., for a certain distance along the intended path of the controlled vehicle.

The vehicle condition detecting part 22 detects the vehicle operation state being set or imposed by the vehicle operator when not performing vehicle operation control processing. For example, the amount of operations of an accelerator, a steering angle, and the existence of a brake pedal operation, the acceleration along at least three axes, yaw-rate, and speed are detected for the controlled vehicle.

The operational characteristics set part 23 sets the operational characteristics according to input from or historical information relating to the operator. Operational characteristics are based on both the data received from the vehicle condition detecting part 22 and/or the settings in the operator preferences set part 24 discussed in more detail below. Using this information, the vehicle operation control system can determine the appropriate speed for travel through an approaching curved portion of the roadway to ensure that the lateral acceleration remains within both the capability of the controlled vehicle and/or the preferences of the operator.

The curve radius information is obtained from the road data corresponding to the link radius provided by the vehicle navigation device 9. The operator preferences set part 24 provides the controlled vehicle operator's general preferences with regard to various vehicle operational characteristics (speed related with the curve radius in a curve way, acceleration, yaw-rate) to provide, for example, a gentle ride, a moderate ride or a sporty or aggressive ride based on the operator's inputs or history.

The other vehicle information acquisition part 25 can obtain radar information (the distance to the reflective object, the relative velocity and the relative position of the reflective object) from radar 7. Other vehicle information including, for example, road traffic information may also be received through infrastructural communication device 14 and through receipt of oncoming vehicle information. Still other information may be obtained with respect to the leading vehicle, passing or pacing vehicles and/or following vehicles and traffic flow conditions and vehicular status along the anticipated route of the controlled vehicle.

The absolute rule set part 26 defines one or more absolute rules that will be the control principle(s) for operation of the adaptive cruise control and/or lane maintenance control devices. Initially, the absolute rule set part 26 defines an absolute rule set taking into consideration various road pertinent information including, for example, traffic signals, road signs, roadway markings, crossings, upcoming curved portions of the roadway, etc., as provided by the acquisition part 21. Such information may include, for example, stopping at a crossing at which the control signal is displaying a red signal at least 100 m before reaching the crossing; stopping at a stop point (stop line); and slowing to enter curved portions of the roadway.

And finally, the absolute rule set part 26 defines an absolute rule set which takes into consideration the controlled vehicle operational characteristics as provided by the operation characteristics set part 23 and operational characteristics retrieved from the external storage device 17 for adjusting the preliminary absolute rule set developed from the data provided by road information acquisition part 21. Examples of such modifications include, for example, increasing the deceleration distance on the approach to a crossing or a stop point to provide for a more gradual and gentle stopping motion; modifying the speed at which curved portions of the roadway will be traversed to limit lateral acceleration and provide a more gentle ride, thereby increasing the comfort of the operator and/or passengers.

In this manner, the vehicle operation control system according to the invention both defines a preliminary or initial absolute rule set based on road pertinent information and can modify the preliminary absolute rule set in light of, for example, various vehicle operational characteristics, operator preferences, and/or type of vehicle.

The relative rule set part 27 defines a relative rule set used for the control principle in the adaptive cruise control and lane maintenance control operations directed by the vehicle operation control part 28 is set up. In this manner, the relative rule set part 27 can define one or more the relative rules to allow temporary deviations from the absolute rule set in response to the relative operation of other vehicles.

For example, information corresponding to a leading vehicle, oncoming vehicles, passing or pacing vehicles, the last vehicle stopped in an approaching traffic jam, etc., may be detected by the other vehicle information acquisition part 25. Based on this information, the vehicle operation rule sets may be modified as necessary to maintain a separation distance between the controlled vehicle and one or more other vehicles (e.g., maintain a separation time interval between the controlled vehicle and a leading vehicle) correspond to the vehicle velocity when leading vehicle exists and/or alter the position of the controlled vehicle within the selected travel lane to maintain or increase lateral spacing relative to a passing or pacing vehicle.

The vehicle operation control part 28 sets the control principles or parameters for the adaptive cruise control or lane maintenance control operation based on the absolute rule set provided by the absolute rule setting means 26 set up and the relative rule set provided by the relative rule setting means 27. In this manner, the vehicle operation control part 28 can define and redefine a range of situation specific control principle and thereby reduce the danger for controlled vehicle and/or provide the operator and/or passengers with a more safe and secure feeling.

Thereby, vehicle operation control systems according to the invention, are not constrained to a relative rule set or an absolute rule set, but will control the vehicle according to control principles derived from both rule sets. For this reason, this vehicle control device 100 can improve both the overall safety of the vehicle operation while improving the subjective impressions of the operator and/or passengers with regard to the prudent and safe operation of the controlled vehicle.

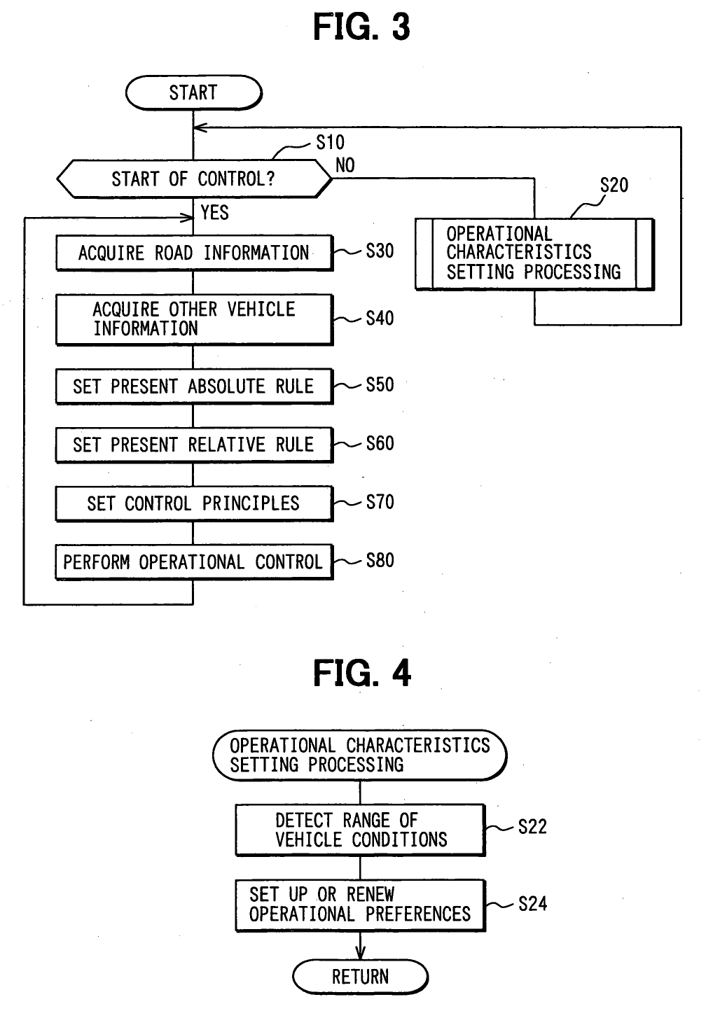

FIG. 3 illustrates a flow chart reflecting the operation of an embodiment of a vehicle operation control system according to the invention using a vehicle operation control device 100. As reflected in FIG. 3, in Step 10 the system determines whether the adaptive cruise control or/and lane maintenance control have been engaged. If these controls have been engaged, the process proceeds to Step 30 while if the controls have not been engaged, the process diverts through Step 20 so that the necessary operational characteristics setting processing may be performed.

The operational characteristics setting processing of Step 20 is illustrated in FIG. 4 wherein Step 22 involves detecting a range of vehicle conditions, Step 24 involves setup or renewal of an operator's operational preferences for defining general operation characteristics for the control system.

Returning to the process flow illustrated in FIG. 3, road information is acquired at Step 30, other vehicle information is acquired at Step 40, an absolute rule set is defined in Step 50 and a relative rule set is defined in Step 60. As will be appreciated, Steps 30-60 may be performed in other sequences so long as the absolute rule set and the relative rule set are both available for use in setting the control principles or parameters in Step 70. Step 80 involves performing vehicle operational control according to the control principle(s) defined in Step 70.

Thus, embodiments of the vehicle operation control device 100 perform vehicle operational control according to control principle(s) based on both a relative rule set that addresses the spatial relationship(s) between the controlled vehicle and other vehicle(s) and an absolute rule set that defines the bounds within which the vehicle operation control device performs.

The example described below reflects vehicle operation control processing by a vehicle operation control device 100 according to an embodiment of the invention.

### EXAMPLE 1

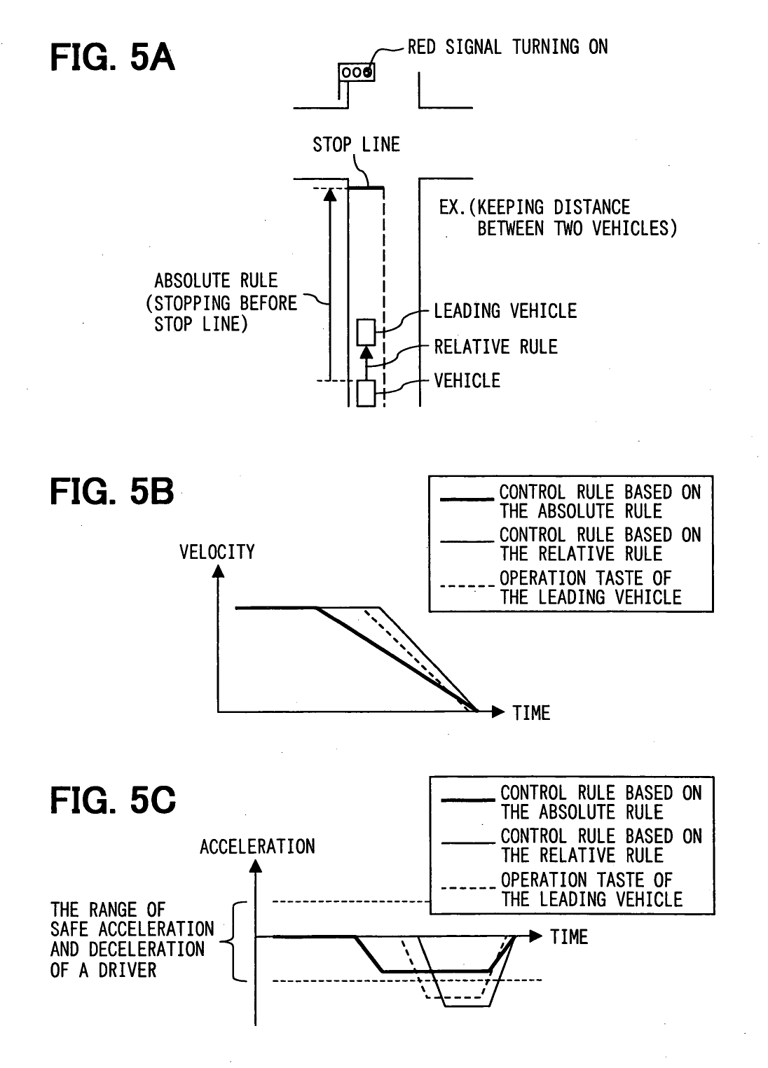

FIG. 5A illustrates a situation wherein the controlled vehicle is approaching a crossing at which a signal is expected while operating under adaptive cruise control. An exemplary absolute rule set which could be utilized based on road information in such a situation could include rules “proceed through the crossing if the signal is activate and green,” “stop before the stop line if the signal is activated and red” and “stop before the stop line if the signal is inactive.” A corresponding relative rule set could include the rules “stop before the stop line if pedestrians are present in the crosswalk,” “stop if another vehicle is entering the intersection,” and “maintain a two second following period behind a leading vehicle.”

Here, if the decision is made to stop the vehicle, the manner in which the vehicle is stopped will depend on the speed of the controlled vehicle, the behavior of a leading vehicle, the distance to the stop line at the time the decision to stop is made and the level of deceleration that can be generated by the vehicles mechanical and hydraulic systems. In accord with the invention, the manner in which the vehicle is stopped may also depend on the operator's normal driving practices and/or the operator's preferences regarding a preferred stopping procedure. The control principles that control changes in the pattern of the controlled vehicle's speed and acceleration/deceleration with regard to an approaching stop line or intersection will be adapted to provide a safe stop generally within the preferences of the operator based on both the absolute rule set and the relative rule set. By considering these various rule sets, the vehicle operation control device can provide a range of stopping or acceleration profiles that take into account capability, preferences and the performance of other vehicles as illustrated in FIGS. 5B and 5C.

As illustrated in FIGS. 5 B and 5C, the control rule based on a relative rule which refers the change pattern of the vehicle velocity and acceleration/deceleration under the relative rule is set up. The vehicle operation control part 28 sets up the final control rule (control principle) to which an operator's margin of safety degree is increased by basing the control rule on both the relevant absolute rules and the relevant relative rules.

When the controlled vehicle position is not leading a group of two or more vehicles, relying on the relative behavior of the nearest leading vehicle of the group may result in more aggressive braking than is preferred by the operator of the controlled vehicle as illustrated in FIG. 5B. On the other hand, if the controlled vehicle relies on only an absolute rule set, it may delay braking or produce extended braking periods. If the controlled vehicle responds only based on a relative rule set according to the relative motion of the controlled vehicle and the leading vehicle, then the controlled vehicle deceleration timing is also delayed to an extend that the controlled vehicle may approach a stop line much too rapidly to stop safely in the remaining open roadway. Therefore the control may become not suitable to operator's operation taste.

In such a case, as illustrated in FIGS. 5B and 5C, it is assumed that the closest leading vehicle of the group may operate in a manner suitable for operation of the controlled vehicle. An ideal operation of the controlled vehicle according to this assumption is set up as the control rule based on the absolute rule. Therefore the control generally corresponds to the operator's preferences.

When the controlled vehicle is the head of the vehicles group, and in the condition of the controlled vehicle may catch up with the front of vehicles group which runs slow than controlled vehicle, the controlled vehicle may perform deceleration control and adaptive cruise control for front vehicle. However, in case based on the relative rule which performs the adaptive cruise control to the tail end of front vehicles group, the controlled vehicle velocity may slowdown than the front vehicles group temporary. That is, not only worsen the controlled vehicle operation comfort but also the following vehicles may slowdown one after another, therefore traffic jam may occur.

In such a situation, the vehicle operation control device 100 may provide an absolute rule that keeps the velocity of the various vehicles in the group in order to maintain the smooth traffic flow. And the vehicle operation control device 100 performs vehicle speed convergence control as a slowdown starting for not falling below the front vehicles group velocity which would result in the controlled vehicle catching the front vehicles group.

The traffic jam including the controlled vehicle may occur when the controlled vehicle is not the head of the vehicle group and the head vehicle do not have the above mentioned management. In such a case, the operation control device 100 assumes that the head vehicle of the vehicles group would run based on above mentioned management. And the operation control device 100 may set up the absolute rule based on the ideal operation according to the above mentioned management. Thereby, the vehicle operation control device 100 can keep the traffic flow smoothly.

### EXAMPLE 2

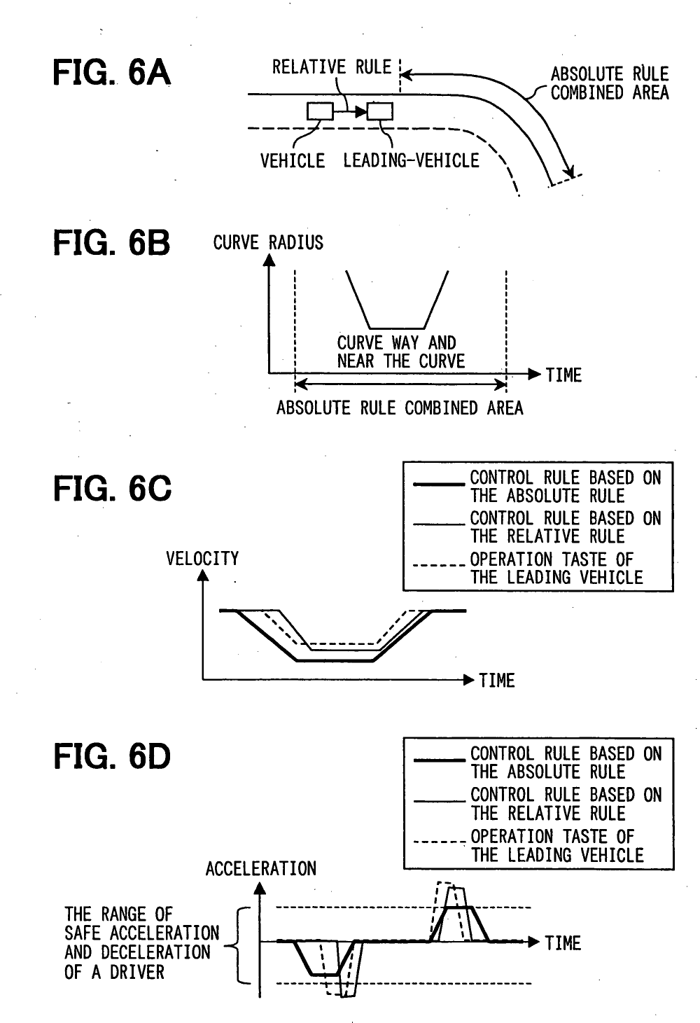

FIG. 6 A shows the situation of operation a curve way, performing the adaptive cruise control. In this situation, the absolute rule which is set up as a standard based on road pertinent information is “slowdown until the controlled vehicle becomes predetermined vehicle speed front of the curve way, and run the curve way at said predetermined vehicle speed”. The relative rule is “keep the prescribed distance between the controlled vehicle and the other vehicle”

Here, the absolute rule used as a standard is applied in the area (absolutely rule combined use area) illustrated in FIG. 6 B. The range of safe acceleration and deceleration of the operator is set up from a operator's operation characteristics (the degree of acceleration and deceleration at the time of the operator usually operating). For this reason, as illustrated in FIGS. 5 C and D, the controlled vehicle may slowdown until the controlled vehicle velocity is deemed to be within the range of safe acceleration and deceleration based on said the absolute rule as a standard and the range of the safe acceleration and deceleration. And the operation control device 100 may set up control rule (based on the absolute rule) reflected in the changed pattern of acceleration and deceleration when the controlled vehicle proceeds through a curved section of roadway at predetermined speed.

It is useful that the operation control device 100 may set up the control rule based on the range of safe acceleration and deceleration depending on the operation characteristics of the controlled vehicle.

And also, as illustrated in FIGS. 5C and 5D, the control rule (based on the relative rule) illustrated the change pattern of the vehicle speed and acceleration according to the relative rule is set up. The vehicle operation control part 28 may set up the final control rule (control principle) to which a operator's degree of safety becomes higher based on the control rule according to the absolute rule and the relative rule. And the vehicle operation control part 28 performs control based on this control principle.

When the vehicles group is in front of the controlled vehicle and this vehicles group will advance into the curve way, this vehicle group may slowdown before the curve. In case, when the controlled vehicle will catch up with this vehicle group and perform the adaptive cruise control, the controlled vehicle velocity may slowdown than the vehicles group velocity temporally. In this case, controlled vehicle driving comfort will be worse, and also the behind-vehicles of controlled vehicle will slowdown one after another, therefore traffic flow will worsen.

In the case of such a situation, a vehicle operation control device 100 sets up the absolute rule as keeping the traffic flow smoothly according to predicting the tail end vehicle speed in the front vehicle group. And a vehicle operation control device 100 adjusts vehicle speed so that an unnecessary slowdown may not occur. Thereby, a vehicle operation control device 100 can also maintain a traffic flow smoothly.

Apart from the above, such as a mountain road which may need an experience for driving, the operation control device 100 will detect the unsteady degree of the steering operation of operator, the unsteady degree of the operation condition in the intended lane, and the side difference degree in the intended lane by operator's operation. And the vehicle operation will judge the degree to which the vehicle's capabilities are suitable (or unsuitable) for driving on this road. Based on this judging result, the operation control device 100 may perform down control of vehicle speed and acceleration. The operation control device 100 may be acceptable this additional control rule based on such the above mentioned operator's inherent absolute rule.

### EXAMPLE 3

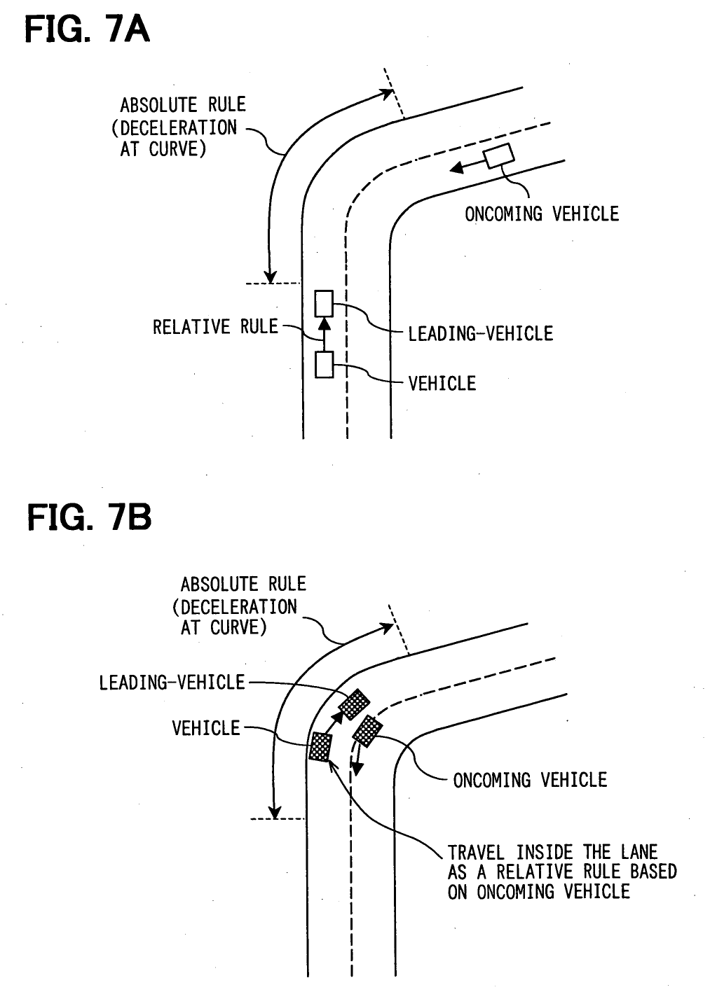

FIG. 7 shows the situation of approaching the oncoming vehicle to the controlled vehicle, when the controlled vehicle is performing the adaptive cruise control and the lane maintenance control which controls operation the center of the intended lane, and the controlled vehicle is operation the curve way. In such the situation, the absolute rule as a standard which sets up based on the road pertinent information is “slowdown until the controlled vehicle becomes predetermined velocity in front of the curve way, and run at said predetermined velocity” as well as the Example 2.

On the other hand, as illustrated FIG. 7 B, when the oncoming vehicle is operation near the center line or over the center line which is between the opposite lane and intended lane, the relative rule is “keep the prescribed distance to the leading vehicle, and run nearest the right side of the intended lane without near the center of the intended lane” because the controlled vehicle may touch oncoming vehicle when the controlled vehicle will pass the oncoming vehicle on.

The vehicle operation control part 28 sets up the final control rule (the control principle) to which an operator's degree of safety becomes higher based on the control rule according to the absolute rule and the relative rule. And the vehicle operation control part 28 performs control based on this control principle. Therefore, even if the oncoming vehicle will run over the center line a little, the operation control device 100 can avoid the operator's degree of safety fall as it as possible.

And also, the operation control device 100 can set up the control rule based on the absolute rule which is operation near the right side of the intended lane when the operation control device 100 will judge the controlled vehicle will be operation the blind curve way based on a coordinates position, shape of the curve way on the vehicle navigation system, or prospect by the imaging sensor, and the lane maintenance control makes operate based on this control rule. Therefore, the operator apprehension regarding a possible collision between the controlled vehicle and an oncoming, passing or pacing vehicle(s). Accordingly, the operator's degree of safety may be improved.

When above mentioned lane maintenance control is performed which is the controlled vehicle runs near the right side of the intended lane on the curve way, the degree of margin to the lane line comes small. Therefore, depending on this degree of safety or safety margin, the operation control device 100 may have the additional control rule according to the absolute rule which controls vehicle velocity and acceleration along a particular curved section of roadway, thereby improving the occupants' degree of safety.

When the side lane operation vehicle (parallel operation vehicle or oncoming vehicle) in front of controlled vehicle exists near the intended lane, or said side lane operation vehicle is moving to near the intended lane, or said side lane operation vehicle is unsteady operation state, even if the controlled vehicle performs the adaptive cruise control based on the relative rule, the operation control device 100 may set up the control principle adding the other relative rule which is the vehicle velocity control which becomes small velocity difference between the controlled vehicle and the other vehicle or deceleration down control. Thereby, the operator's degree of safety may be improved.

When the side lane operation vehicle in front of the controlled vehicle will stop different lane, the operation control device 100 may cancel said velocity control and deceleration control. Thereby, the operator's degree of safety may keep higher.

Although the invention has been described in connection with certain exemplary embodiments, it will be evident to those of ordinary skill in the art that many alternatives, modifications, and variations may be made to the disclosed methods in a manner consistent with the detailed description provided above. Also, it will be apparent to those of ordinary skill in the art that certain aspects of the various disclosed example embodiments could be used in combination with aspects of any of the other disclosed embodiments or their alternatives to produce additional, but not herein illustrated, embodiments incorporating the claimed invention but more closely adapted for an intended use or performance requirements. Accordingly, it is intended that all such alternatives, modifications and variations that fall within the spirit of the invention are encompassed within the scope of the appended claims.

1. A vehicle operation control system comprising;
a road information acquisition device;
a controlled vehicle information acquisition device;
an other vehicle information acquisition device;
an absolute rule setting device;
a relative rule setting device,
a vehicle operation control device for controlling a controlled vehicle in response to operating principles developed from information received from both the absolute rule setting device and the relative rule setting device.

2. The vehicle operation control system according to claim 1, wherein:
the vehicle operation control device modifies the operating principles in response to information received from the relative rule setting device to increase separation distance between the controlled vehicle and another vehicle.

3. The vehicle operation control system according to claim 2, wherein:
the vehicle operation control device modifies the operating principles to direct the controlled vehicle from a centered position to an offset position within a selected lane to increase the separation distance between the controlled vehicle and another vehicle.

4. The vehicle operation control system according to claim 1, wherein:
the vehicle operation control means modifies the operating principles in response to information received from the absolute rule setting device to accommodate an operator preference.

5. The vehicle operation control system according to claim 4, wherein:
the vehicle operation control means modifies the operating principles to increase the stopping distance and limit a stopping deceleration force.

6. The vehicle operation control system according to claim 4, wherein:
the vehicle operation control means modifies the operating principles to reduce speed through curved portions of a roadway and thereby limit a lateral acceleration force.

7. The vehicle operation control system according to claim 1, wherein:
a road information acquisition device develops a road data set corresponding to an anticipated route for the controlled vehicle.

8. The vehicle operation control system according to claim 7, wherein the road information acquisition device develops said road information relating to at least one parameter selected from a group consisting of road condition, road width, traffic control signals, road signs, traffic signs, crossing roadways, merging roadways, diverging roadways, curved roadway portions, and road slope.

9. The vehicle operation control system according to claim 1, wherein:
an operational characteristics setting device develops a set of operator specific operational characteristics during an operator's operation of the controlled vehicle.

10. The vehicle operation control system according to claim 1, wherein:
a vehicle condition setting device develops a set of vehicle specific operational characteristics during operation of the controlled vehicle.

11. The vehicle operation control system according to claim 1, wherein:
an operational preferences setting device develops a set of operator specific operational characteristics based on an operator's input.

12. The vehicle operation control system according to claim 1, wherein:
a road information acquisition device develops a road data set corresponding to an anticipated route for the controlled vehicle;
an operational characteristics setting device develops a set of operator specific operational characteristics during an operator's operation of the controlled vehicle;
a vehicle condition setting device develops a set of vehicle specific operational characteristics during operation of the controlled vehicle; and
an operational preferences setting device develops a set of operator specific operational characteristics based on an operator's input.

13. The vehicle operation control system according to claim 12, wherein:
the absolute rule setting device develops an absolute rule set from one or more data sources selected from a group consisting of a road data set corresponding to an anticipated route for the controlled vehicle, a set of operator specific operational characteristics, a set of vehicle specific operational characteristics; and a set of operator specific operational characteristics.

14. The vehicle operation control system according to claim 1, wherein:
the vehicle operation control device provides an adaptive cruise control function and a lane maintenance function.

15. The vehicle operation control system according to claim 14, wherein:
the adaptive cruise control function maintains a minimum separation distance between the controlled vehicle and a leading vehicle.

16. The vehicle operation control system according to claim 15, wherein:
the minimum separation distance is determined in light of at least one factor selected from a group consisting of current speed of the controlled vehicle, brake system capability, road surface condition and road surface incline.

17. The vehicle operation control system according to claim 1, wherein:
the vehicle operation control device is configured for selective engagement and controlled manipulation of at least two vehicular controls selected from a group consisting of a throttle, a steering assembly, a brake assembly and a transmission, thereby operating the controlled vehicle in a manner consistent with the operating principles.

18. The vehicle operation control system according to claim 1, wherein:
the operating principles are periodically revised in response to the information received from the relative rule setting device reflecting changes in the other vehicle information.

19. The vehicle operation control system according to claim 18, wherein:
the operating principles remain within operational bounds defined by the absolute rule setting device.

20. The vehicle operation control system according to claim 1, further comprising:
an alarm for alerting the operator to potential violations of the operating principles.

21. The vehicle operation control system according to claim 1, further comprising:
a failsafe rule set for reducing risk associated with unavoidable violations of the operating principles.

22. The vehicle operation control system according to claim 12, wherein:
an operational characteristics setting device develops a set of operator specific operational characteristics during an operator's operation of the controlled vehicle including at least one of accelerator activation, transmission settings, steering input and brake activation;
a vehicle condition setting device develops a set of vehicle specific operational characteristics during operation of the controlled vehicle including at least one of vehicle velocity, acceleration, deceleration and yaw-rate;
an operational preferences setting device develops a set of operator specific operational characteristics based on an operator's input.
